(19) United States
(12) Patent Application Publication
(10) Pub. No.: US 2005/0059913 A1
(43) Pub. Date: Mar. 17, 2005

(54) Massage device

(76) Inventors: Fumitaka Ishiguro, Sida-gun (JP); Tetsuya Ishikawa, Ogasa-gun (JP)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/748,895

(22) Filed: Dec. 30, 2003

(30) Foreign Application Priority Data
Sep. 12, 2003 (JP) 2003-321908

(51) Int. Cl. A61H 7/00

(52) U.S. Cl. 601/90

(57) ABSTRACT

A massage device. The massage device includes a pair of therapeutic elements and a bottom therapeutic member. The therapeutic elements are rotated by a driving shaft, driven by a driving mechanism, for supporting and massaging feet. The bottom therapeutic member is disposed between two therapeutic elements, supporting an instep of a foot. The therapeutic elements are formed along the instep of the foot.

### BACKGROUND OF THE INVENTION

1. Field of the Invention

The present invention relates to a massage device, and in particular to a massage device for massaging and stimulating the sole of the foot.

2. Description of the Related Art

In a conventional massage device disclosed by Japan patent No. 2001-224648, in order to provide foot massage and stimulation, an outer periphery thereof is protruded at an acute angle. A plurality of therapeutic rollers with circular, rigid arc-shaped elements having a radius of curvature of 10 mm to 15 mm are supported by rotating shafts. A locus of rotary motion of the rotating shafts is determined by uniquely shaped members. Each rotating shaft has a row of the therapeutic rollers provided thereon. A row of therapeutic rollers represents a therapeutic rolling piece group, each row having cross sections according to the shape of the outer periphery of the uniquely shaped members. The rotating shafts move along the outer periphery of the uniquely shaped members. The shape of the outer periphery of the uniquely shaped members forms the locus of motion of the rotating shafts. As a result, if the shape of the outer periphery of the uniquely shaped members conforms to the shape of an ankle and foot arch, the massage device unevenly stimulates the bottom of the toes and the arch of the entire sole of the foot when placed thereon.

Because the purpose of the conventional massage device is to stimulate the entire sole of the foot by the uniquely shaped members, the device also stimulates the sole of the foot where stimulation is ineffective, thus, increasing unnecessary driving time for stimulation.

Hence, there is a need for a massage device providing effective foot massage and stimulation, especially focusing on the particular portions of the sole of the foot to shorten the massaging time.

### SUMMARY OF THE INVENTION

Thus, an object of the invention is to provide a massage device for effective foot massage and relatively better stimulation in a short time.

The present invention provides a massage device including a plurality of rollers, having a therapeutic protrusion, facing two intended locations of a sole and an arch of the foot, generating pressure higher than pressure exerted by the surface of the foot. The rollers are rotatably driven in a predetermined direction by a driving mechanism. Thus, the present invention effectively provides stimulation particularly on two locations, the sole of the forefoot and the arch of the foot, in a short period of time.

The present invention further provides a massage device including a plurality of rollers, having a therapeutic protrusion, facing three intended locations of a sole of a foot, an arch, and a heel of the foot, generating pressure higher than pressure exerted by the surface of the sole of the foot. The rollers are rotatably driven in a predetermined direction by a driving mechanism. Thus, the present invention effectively provides stimulation particularly on three locations: the sole of the forefoot, the foot arch, and the heel, in a short period of time.

Any two adjacent rollers are rotatably driven by in opposite directions. Thus, the foot does not move with the rollers.

The therapeutic protrusion on the rollers is disposed on an outer surface thereof, and freely supported by the roller. Thus reducing friction between the foot and the roller and the foot does not move with the rollers for better and easier foot massage.

Furthermore, the rollers include a plurality of rotational shafts, disposed on the same level. One of the rollers has a protrusion facing the foot arch and a driving locus closer to a therapeutic portion than a driving locus of a protrusion on one of the rollers facing a portion of the foot other than the arch. The roller for the arch of the foot has a diameter greater than the other rollers, and thus, peripheral velocity is increased, providing varied massaging sensations for the arch of the foot and other portions thereof. Particularly, the device provides comfortable sensation during massage.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective view of a massage device according to a first embodiment of the present invention;

FIG. 2 is a side view of FIG. 1 observed from direction A;

FIG. 3 is a top view of FIG. 2 observed from direction B;

FIG. 4 is a front view of FIG. 1 observed from direction C;

FIG. 5 is a front view of the therapeutic elements of FIGS. 1-4;

FIG. 6 is a cross section of FIG. 5 taken along line ST-ST;

FIG. 7 is an exploded perspective view of the therapeutic element of FIGS. 5 and 6;

FIG. 8 is a perspective view of the driving mechanism of FIG. 1;

FIG. 9 is a side view of FIG. 8 observed from direction D;

FIG. 10 is a top view of FIG. 9 observed from direction E;

FIG. 11 is a front view of FIG. 8 observed from direction F;

FIG. 12 is a perspective view of the roller 9 of FIG. 8;

FIG. 13 is a side view of FIG. 12 observed from direction G;

FIG. 14 is a top view of FIG. 12 observed from direction H;

FIG. 15 is a front view of FIG. 12 observed from direction I;

FIG. 16 is a perspective view of the roller 10 of FIG. 8;

FIG. 17 is a side view of FIG. 16 observed from direction J:

FIG. 18 is a top view of FIG. 16 observed from direction K;

FIG. 19 is a front view of FIG. 16 observed from direction L;

FIG. 20 is a perspective view of the roller 11 of FIG. 8;

FIG. 21 is a side view of FIG. 20 observed from direction M;

FIG. 22 is a top view of FIG. 20 observed from direction N;

FIG. 23 is a front view of FIG. 20 observed from direction O;

FIG. 24 is a perspective view of the driving mechanism of FIG. 8;

FIG. 25 is a side view of operations of the massage device according to the first embodiment of the present invention;

FIG. 26 is a side view of operations of the massage device according to the second embodiment of the present invention;

FIG. 27 is a perspective view of the massage device according to the third embodiment of the present invention;

FIG. 28 is a side view of operations of the massage device according to the fourth embodiment of the present invention;

FIG. 29 is a side view of operations of the massage device according to the fifth embodiment of the present invention;

FIG. 30 is a top view of the massage device according to the sixth embodiment of the present invention;

FIG. 31 is a cross section of FIG. 30 taken along line SP-SP;

FIG. 32 is a perspective view of FIG. 30;

FIG. 33 is a perspective view of FIG. 30;

FIG. 34 is a top view of the massage device according to the seventh embodiment of the present invention;

FIG. 35 is a cross section of FIG. 34 taken along line SR-SR;

FIG. 36 is a perspective view of FIG. 34; and

FIG. 37 is a front view observed from S direction of FIG. 34.

### DETAILED DESCRIPTION OF THE INVENTION

First embodiment

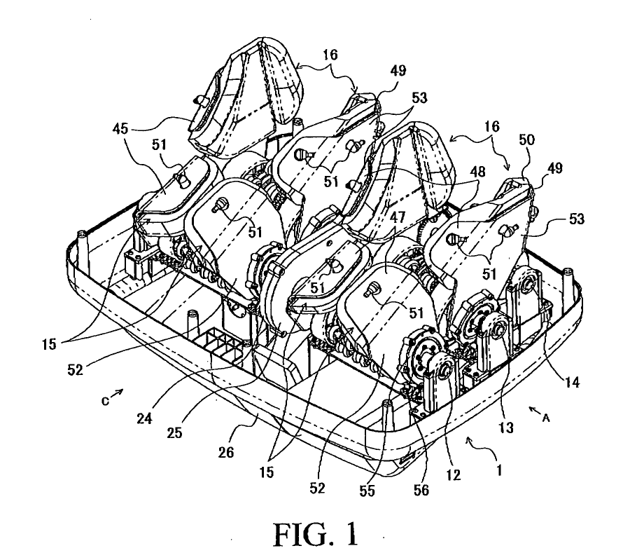

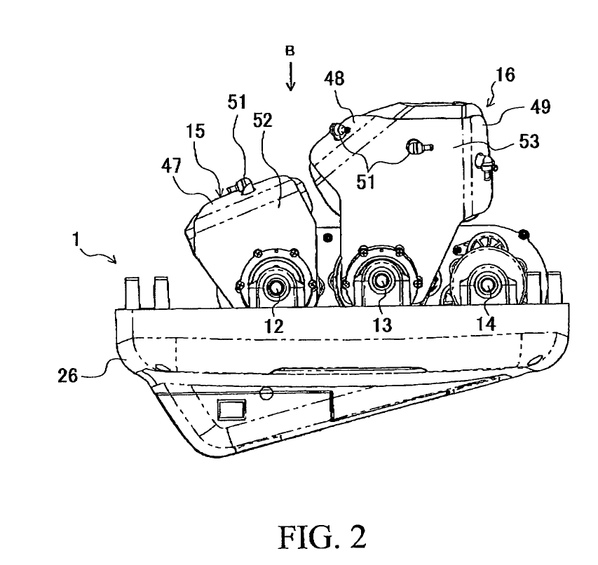

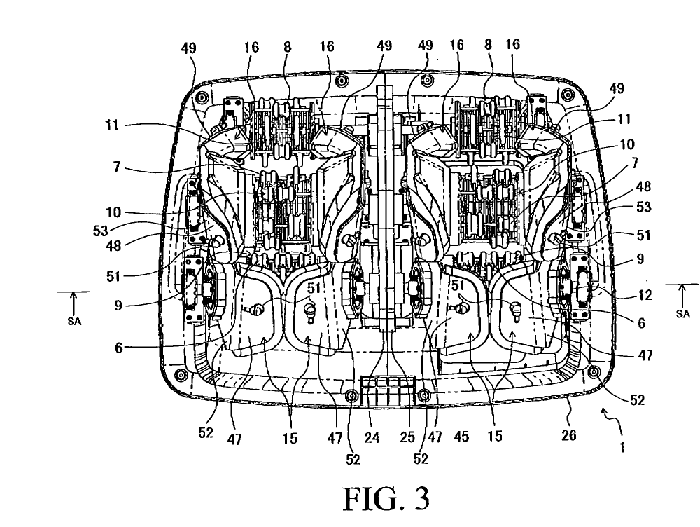

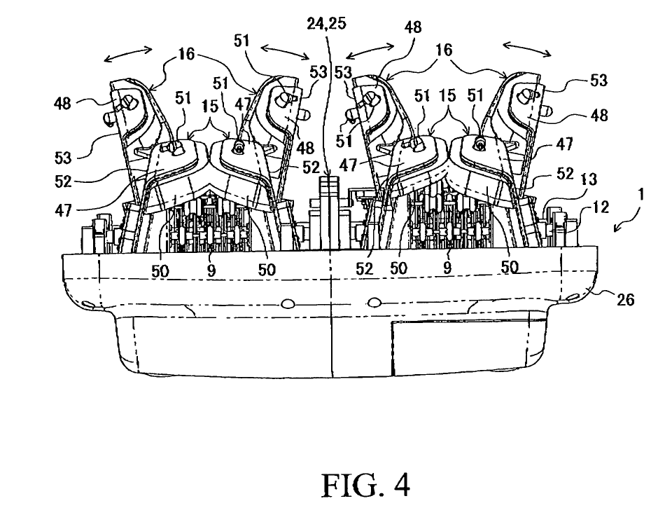

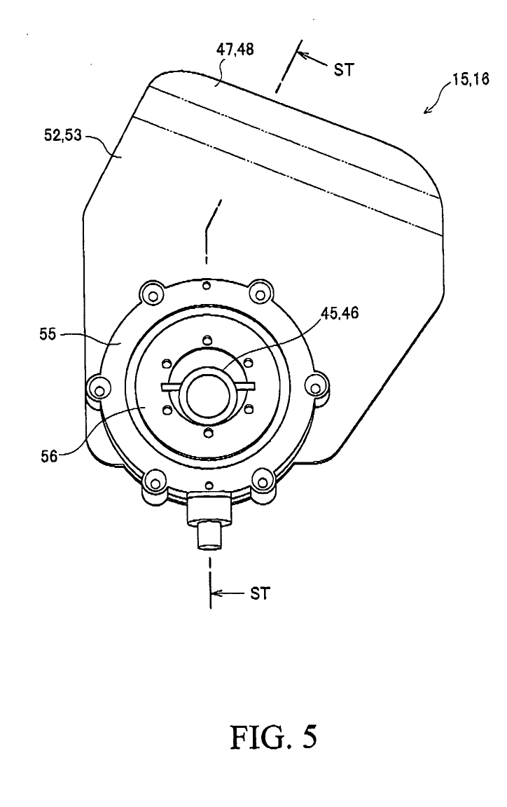

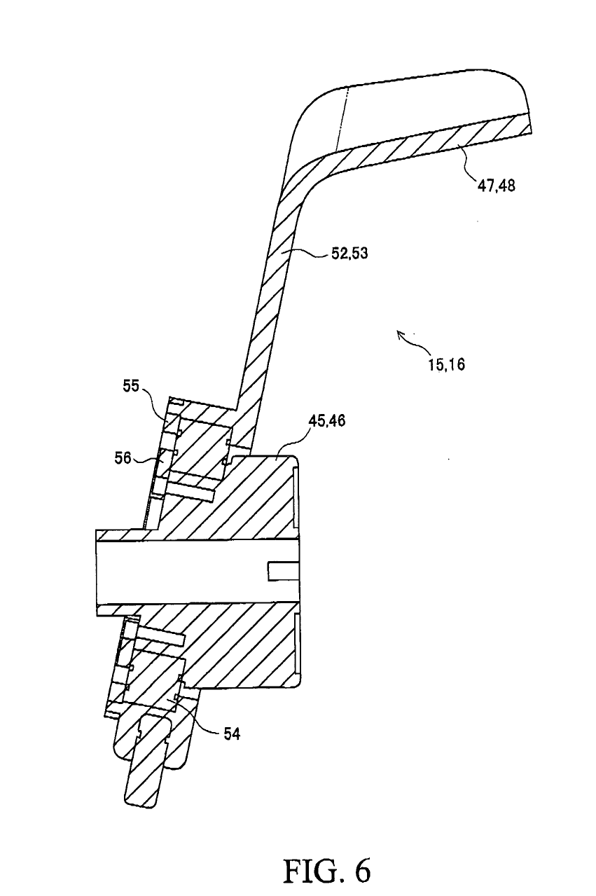

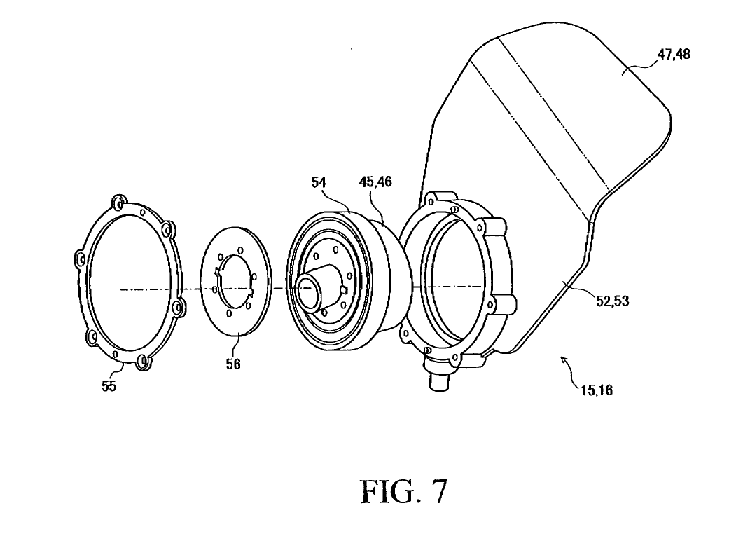

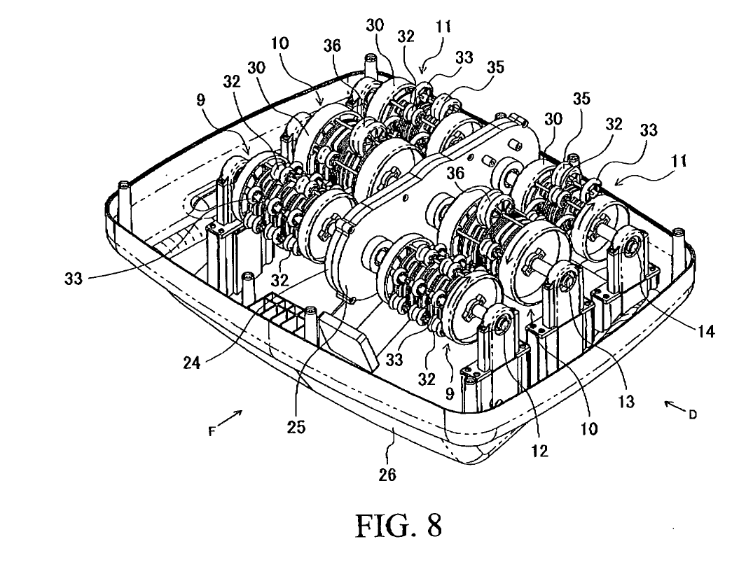

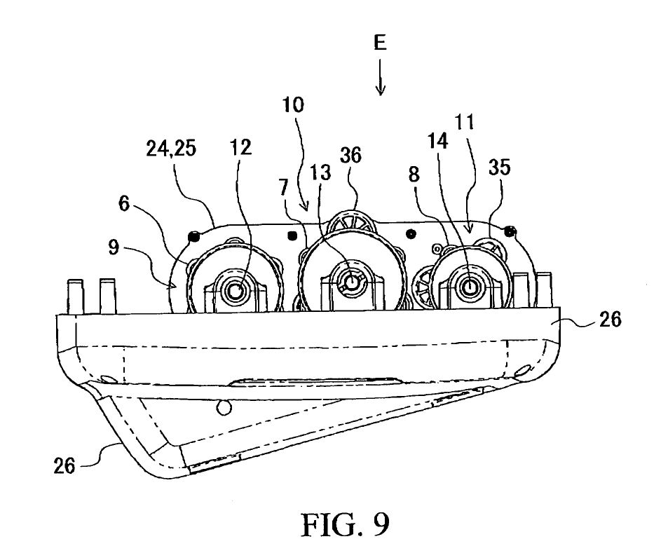

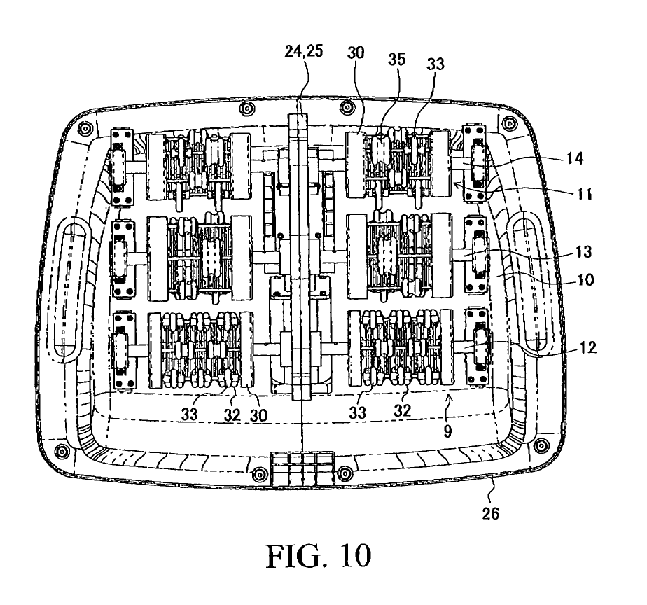

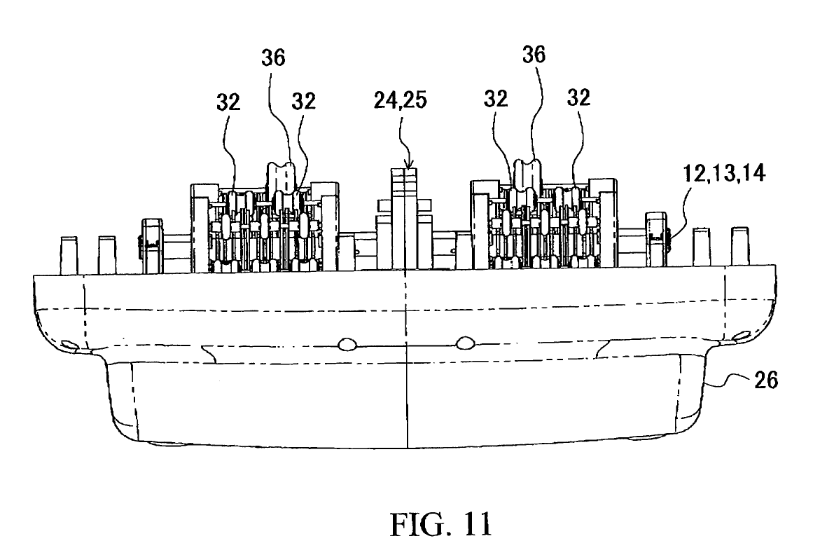

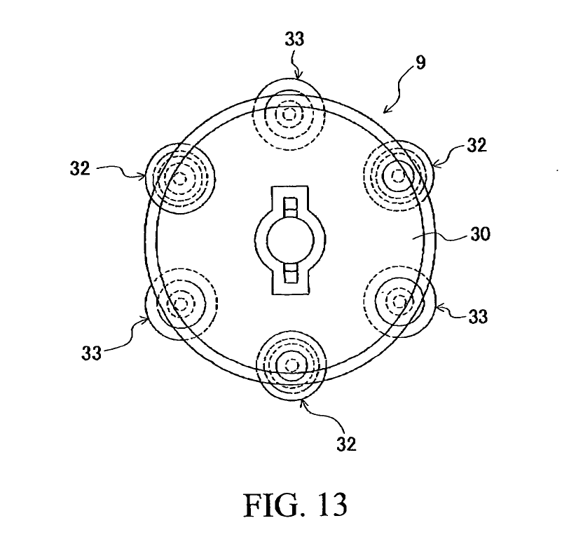

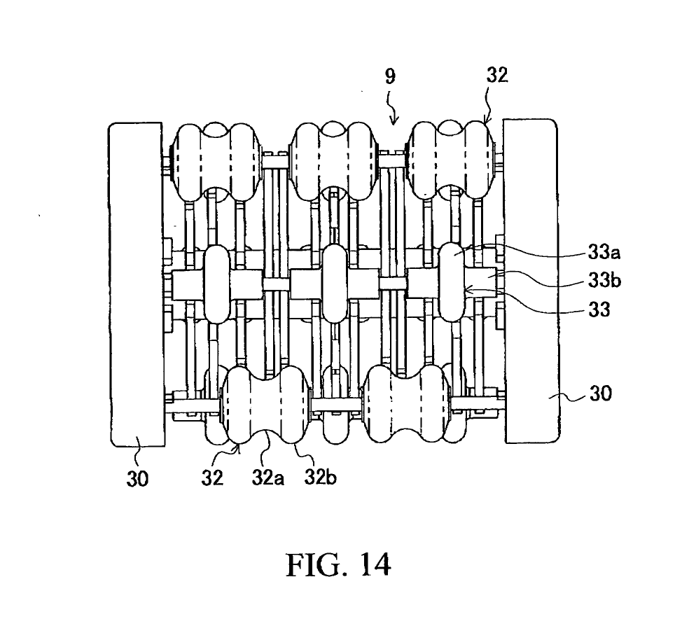

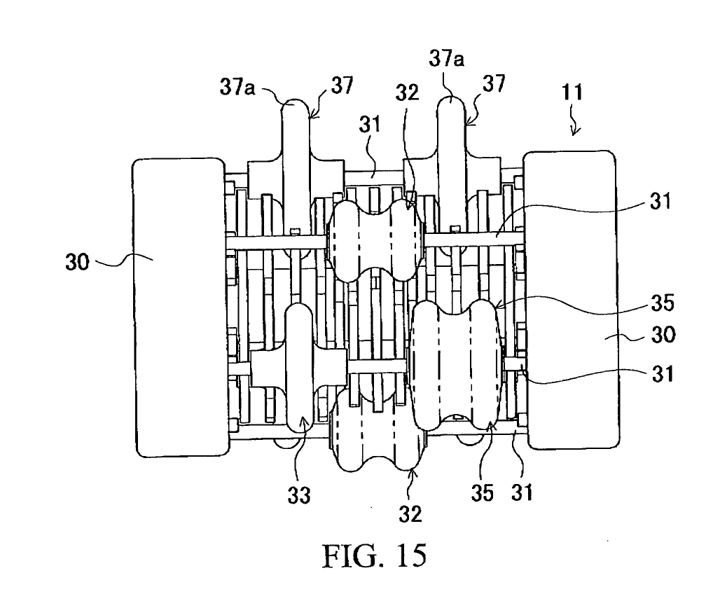

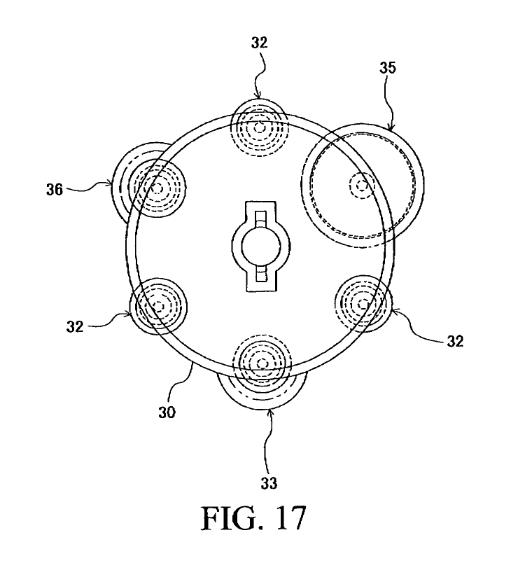

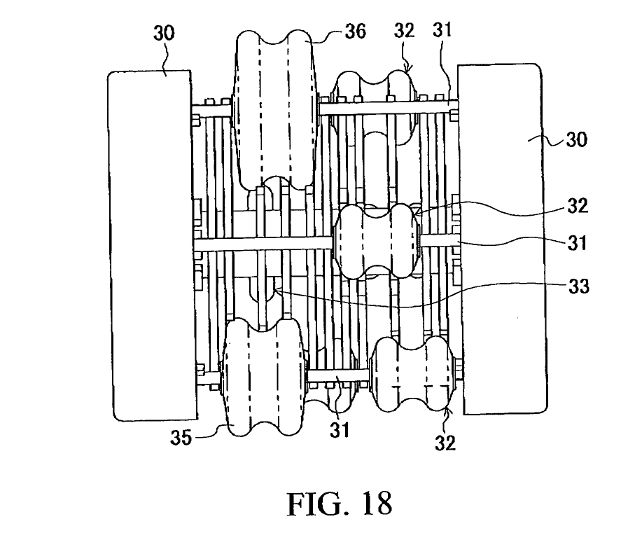

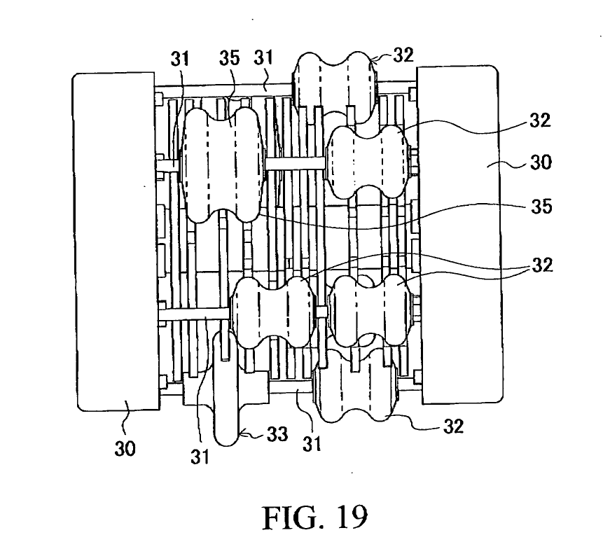

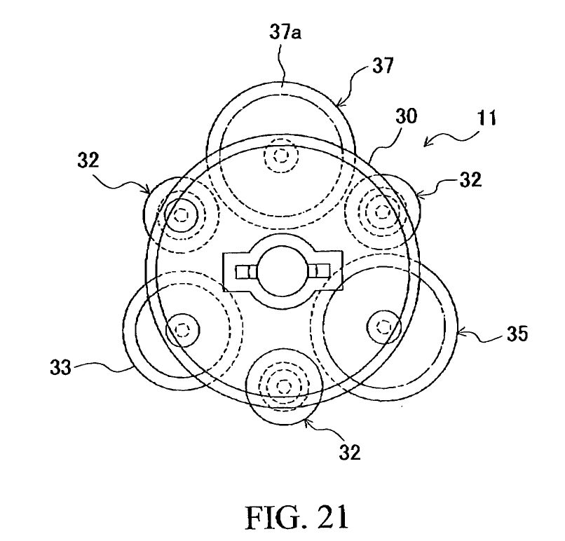

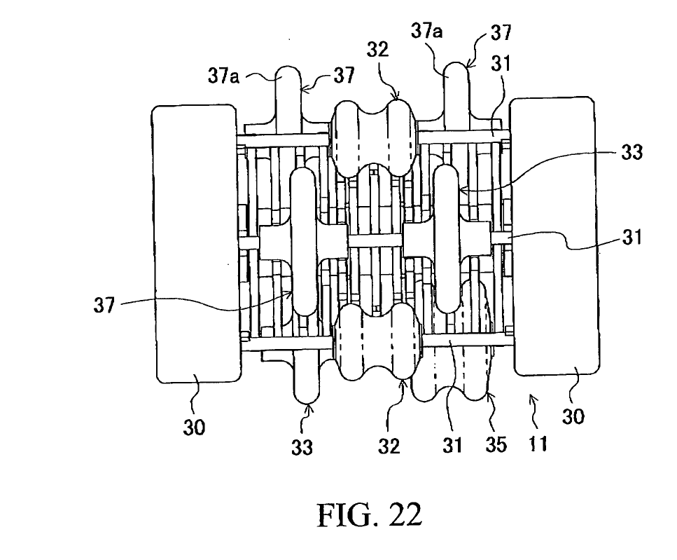

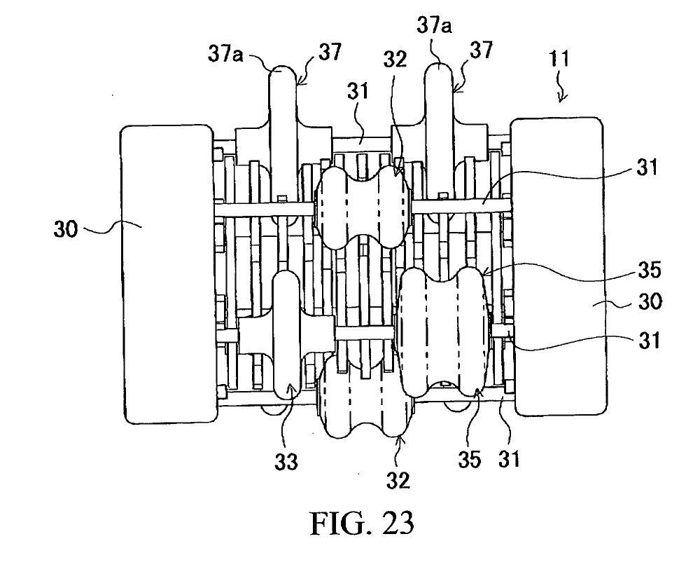

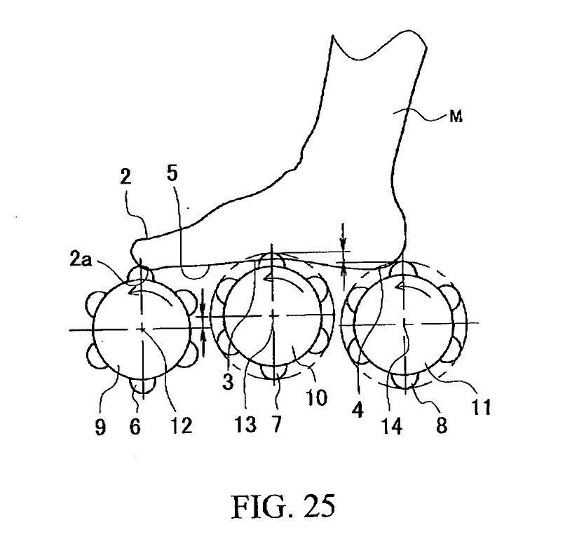

FIGS. 1-25 are schematic views according to the first embodiment of the present invention. The symbol 1 of FIG. 1 represents the massage device. In the massage device 1, rotational driving force of a motor 18 is transmitted to a rotational shaft 19 for worm and helical gears 20, 21, 22 of a decelerating device 17 to drive driving shafts 12, 13, 14. Rollers 9, 10, and 11 are respectively disposed on three locations corresponding to the sole 2a of forefoot 2, the foot arch 3, and heel 4 in FIG. 25. The rollers 9, 10, and 11 are disposed on the driving shafts 12, 13, and 14, respectively, and have therapeutic protrusions 6, 7, 8 for generating pressure higher than typical pressure applied by the sole 5 of the foot. The rollers 9, 10, and 11 are rotatably driven in a predetermined direction by the driving shafts 12, 13, and 14.

The protrusions 6, 7, and 8 and the rollers 9, 10, and 11 are integrated as a unit. A pair of therapeutic elements 15 and 16 for clamping the rollers is disposed in the vicinity of the rollers 9, 10 facing the sole 2a of the forefoot 2 and the foot arch 3. The therapeutic elements 15 and 16 are formed according to the shape of the rollers 9, 10 and 11. The therapeutic elements 15 and 16 are movable between an approaching position and a departing position by the rotation of the driving shafts 12, 13 and 14. The therapeutic elements 15 and 16 clamp to the foot to massage and apply pressure thereon from multiple directions toward three preset locations, the sole 2a of forefoot 2, the arch 3, and the heel 4 of the foot M. The rollers 9, 10, and 11 and the therapeutic elements 15 and 16 are symmetrically and respectively disposed on left and right sides with a certain interval therebetween, and capable of massaging both feet simultaneously.

As shown in FIGS. 1-7, the therapeutic elements 15 and 16 include massaging bases 45, 46, massaging plates 52, 53, and pressure boards 47, 48. The symmetric massaging bases 45 and 46 are fixed in rotational and axial directions of the driving shafts 12, 13. On the outer periphery of the massaging bases 45 and 46, the massaging plates 52 and 53 are inserted at an angle with respect to the driving shafts 12, 13 and fixed by a bearing 54 in an axial direction. The pressure boards 47 and 48 are formed on the top end of the massaging plates 52 and 53. Furthermore, to reach the foot and massage the forefoot instep of the foot M, the pressure boards 47, 48 and the massaging plates 52, 53 form a roughly L-shaped cross section. A flexible guiding portion 49 pressed against a side of the forefoot is formed according to the contour of the forefoot. A flexible member 50 is formed on the opposite side of the pressure boards 47, 48, and the side of the foot. An expandable airbag, not shown in the figure, is disposed between the pair of pressure boards 47, 48 and the flexible member 50. An air supply source on the airbag has a pipe 51 for discharging air. It is possible that the pressure level may become excessive; hence, the pipe is provided with a mechanical valve for safety. Additionally, the symbol 55 represents a pressure board of the bearing 54. The symbol 56 represents a pressure board for holding the massaging plates 52, 53 on the massaging base 45, 46.

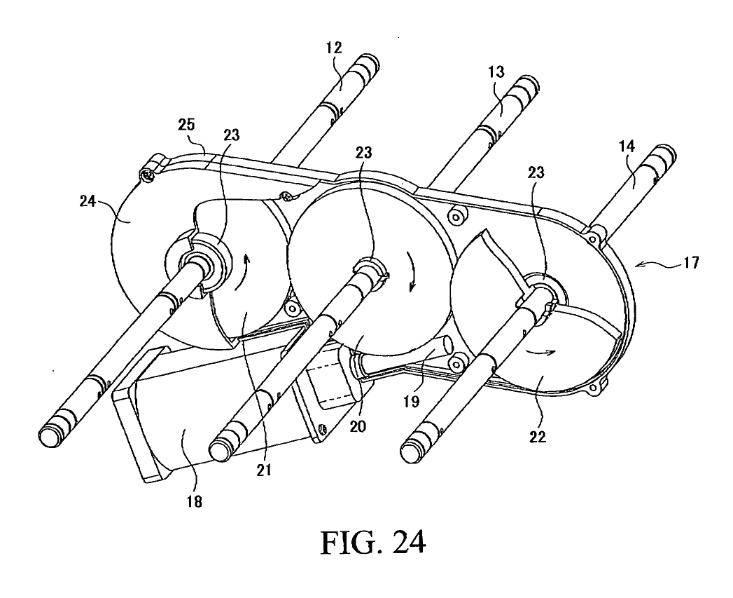

As shown in FIG. 24, the decelerating device 17 is formed by a worm gear on the rotational shaft 19 of the motor 18, fixed on the gear case (not shown). The motor 18 is meshed with the helical gear 20 on the worm of the rotational shaft 19, for decelerating rotational speed. The deceleration can be achieved by any means. By meshing with the helical gear 20, the helical gears 21, 22 with the same reduction gear ratio face the helical gear 20, which is the intended the location for the arch of the foot. As a result, the helical gears 21 and 22 are disposed facing the sole 2a of the forefoot 2 and the heel 4, respectively. Furthermore, the helical gear 20 is located higher than the axes of the helical gears 21, 22 and disposed closer to the therapeutic elements 15 and 16. The helical gear 20 is turned in a direction opposite to the rotational direction of the helical gears 21, 22 by a suitable tool. The helical gears 20, 21, and 22 are supported by the bearing 23 for free rotation and fixed on the center of the driving shafts 12, 13, and 14 passing through the gear case 23 and 25 in rotational and axial directions. Thus, each helical gear 20, 21, and 22 is rotated accordingly. The symbol 26 is a container for receiving the motor 18.

An adequate interval is provided on each driving shaft 12, 13, or 14 for clamping gear cases 24, 25, and the interval is roughly equivalent to shoulder width when feet are placed naturally thereon. The rollers 9, 10, and 11 and the driving shafts 12, 13, and 14 are fixed in the same rotational and axial direction. The rollers 9, 10, and 11 are rotated with the driving shafts 12, 13, 14. The rollers 9 and 10 are disposed relatively close to each other. Compared to the rotational direction of the roller 9 toward the front side, the roller 10 rotates to the back side, in an opposite direction. Thus, the therapeutic protrusions 6, 7, and 8 on the surface of the rollers 9, 10, and 11 are freely rotatable with respect to the rollers 9, 10, and 11.

The rotational shafts 12, 14 of the rollers 9, 11 shown in FIG. 25 are disposed on the same level, facing the position intended to support the foot arch 3. The protrusion 7 on the roller 10 for the foot arch 3 has a locus closer to the foot arch 3 as a therapeutic portion than the locus of the protrusions 6, 8 on the other rollers 9 and 11 intended to face the sole 5 of the foot, and thus, the rotational shafts 12 and 14 support the rotational shaft 13 in the above manner.

The following descriptions explain the roller 9 having a protrusion 6, facing the intended portion of the sole 2a of the forefoot 2 of the foot M.

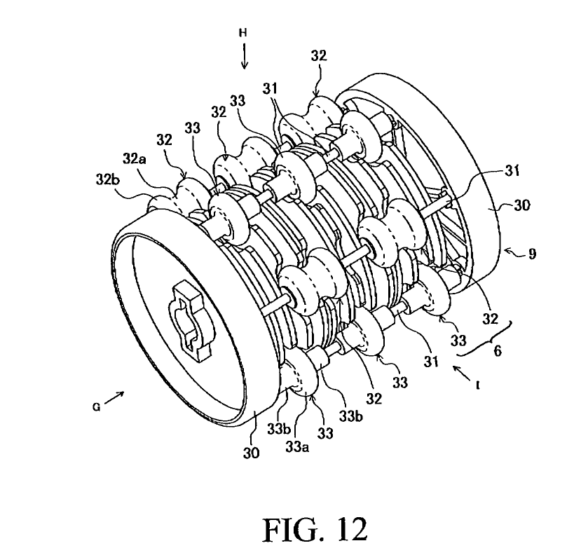

The roller 9, as shown in FIGS. 12 to 15, has six symmetrical protrusions 6 and bodies 30, 30. The protrusions 6 are freely supported between two cylindrical bodies 30 and 30. The protrusions 6 comprise six rods 31, disposed between the bodies 30 and 30, and the first rolling component 32 and the second rolling component 33, freely rotatably supported by the rod 31. The first rolling component 32 is composed of a concave portion 32a at the middle section in leftward and rightward directions, and a left end portion 32b and a right end portion 32b with the same diameter as the roller. The second rolling component 33 has a protrusion 33a, protruding in left and right directions, and axial connecting portions 33b, 33b supporting the rod 31. The diameter of the left end portion 32b and the right end portion 32b of the first rolling component 32 is the same as the protrusion 33a of the second rolling component 33. In one aspect the two first rolling components 32 are supported by one rod 31, and in another aspect three first rolling components are supported by one rod 31. A rod 31 has three second rolling components 33 provided thereon. Thus, on the circumferential periphery of the bodies 30, 30, the second rolling component 33 is disposed between two adjacent first rolling components 32, resulting in an arrangement of three rollers.

The roller 10 having a protrusion 7, facing the intended portion of the foot arch 3 of the foot M, is described in the following.

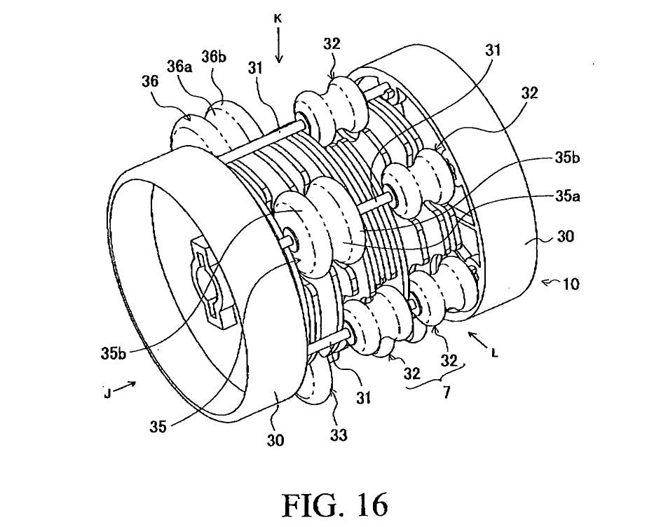

The roller 10, as shown in FIGS. 16 to 19, has six symmetrical protrusions 7 and cylindrical bodies 30, 30. The protrusions 7 are freely supported between left and right sides of the bodies 30 and 30, and arranged at an interval along the circumferential direction. Each protrusion 7 has a rod 31, disposed between the bodies 30 and 30, and first and second rolling components 32, 33, a third and a fourth rolling components 35, 36, freely rotatable and supported by the rod 31. The third rolling component 35 and the fourth rolling component 36 have concave portions 35a, 36a at the middle section in leftward and rightward directions, and left end portions 35b, 36b and right end portions 35b, 36b with the same diameter as the roller. In one aspect two first rolling components 32 on one rod 31, three first rolling components 32 on one rod 31, and the third rolling component 35 are jointly disposed thereon. Only one fourth rolling component 36 disposed on one rod 31.

The roller 11 having a protrusion 8, facing the intended portion of the heel 4 of the foot M, is described in the following.

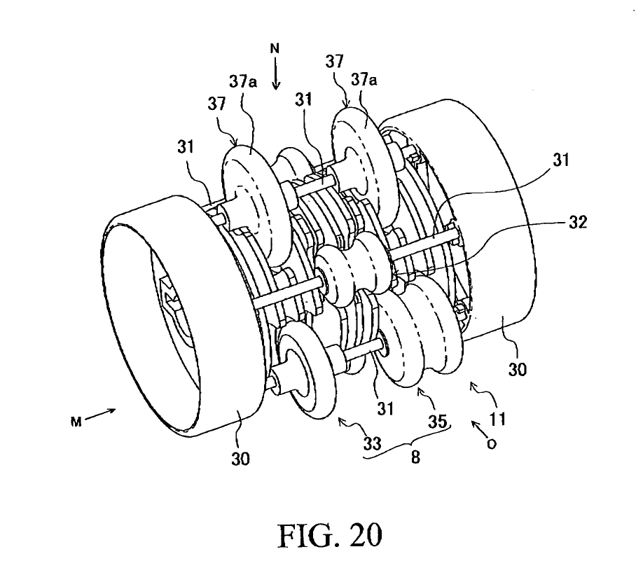

The roller 11, as shown in FIGS. 20 to 23, has six symmetrical protrusions 8 and cylindrical bodies 30, 30. The protrusions 8 are freely supported between left and right sides of the bodies 30 and 30, and arranged at an interval along the circumferential direction. Each protrusion 8 has a rod 31, disposed between the bodies 30 and 30, and the first, second, third and fifth rolling components 32, 33, 35, and 37, freely rotatable and supported by the rod 31. The diameter of the protrusion 37a of the fifth rolling component 37 and that of the protrusion 33a of the second rolling component 33 are equivalent. The first rolling component 32 is disposed between the second, third, fifth rolling components 33, 35, and 37 in a concavo-convex shape. The third rolling component 35 is supported by the rib 31 supporting the second rolling component 33. Two of the fifth rolling components 37 are disposed on one rod 31. Only one first rolling component 32 is disposed on one rod 31. The diameter of the first diameter 32 is smaller than those of the second, third, and fifth rolling components 33, 35, and 37. Thus, stimulation to the heel 4 is reduced, eliminating potential discomfort to the heel. Additionally, the two end portions of the second and the fifth rolling components 33, 37 have a larger outer diameter, thus, enabling massage on the sides of the heel 4.

The operation and structure according to the first embodiment of the present invention is described in the following.

When placed in the three intended portions of the sole 2a of the forefoot 2, arch 3 and heel 4, the rollers 9, 10, and 11 having protrusions 6, 7, and 8 generate higher pressure than the pressure on foot surface 5 exerted by the weight of a typical foot placed thereon, and thus, the sole 2a of the forefoot 2, the foot arch 3, and the heel 4 can be effectively stimulated, particularly in the mentioned three locations, in a short period of time. The protrusion 6 of the roller 9 is wheel-shaped, and has a smaller diameter than the protrusion 7 of the roller 10 intended for the foot arch 3 has. The protrusion 6 of the roller 9 has the same diameter as the first and second rolling component 32, 33. Thus, the present invention provides different massage feeling.

The adjacent rollers 9, 10 and 10, 11 can potentially rotate in opposite directions, and thus the feet are moved by the rollers 9, 10, and 11, providing smooth foot massage.

The therapeutic protrusions 6, 7, and 8 of the rollers 9, 10, and 11 are disposed on the outer surface thereof and rotatably supported by the driving shafts 12, 13, 14, facing the rollers 9, 10, and 11. Thus, the friction between the sole of the foot and the rollers 9, 10, and 11 is reduced, preventing movement of the foot during massage by the rollers. Namely, the foot is more easily massaged. Moreover, the driving shaft 13 of the roller 10 facing the foot arch 3 is disposed higher than the other rollers 9, 11, thus, providing better stimulation on the foot arch 3.

The massaging bases 45 and 46 are rotated by the driving shafts 12 and 13. The angle at which the bearing 54 is inserted in the massaging bases 45 and 46 is varied with the rotational angle. The massaging plates 52 and 53 are disposed on the bearing 54 at the same angle as the slanting angle of the massaging bases 45 and 46. The massaging plates 52 and 53, however, are disposed in the opposite direction, approaching the opposite side, such that the foot M can be placed in the space therebetween for massage. Additionally, since the pressure boards 47 and 48 are formed corresponding to the foot or covering the instep, and when the pressure boards 47 and 48 approach, the foot arch is firmly pressed downward by the pressure boards 47 and 48.

The distance between the therapeutic elements 15 and 16 can be reduced regardless of the restriction in the different foot sizes when the flexible member 50 or airbag is expanded. Thus, the foot is massaged with adequate pressure. Additionally, when the pressure of the airbag is higher than a certain pressure, excess compressed air is discharged by the mechanical valve for safety, suppressing excessive stimulation of the therapeutic parts and increasing durability of the airbag.

Second Embodiment

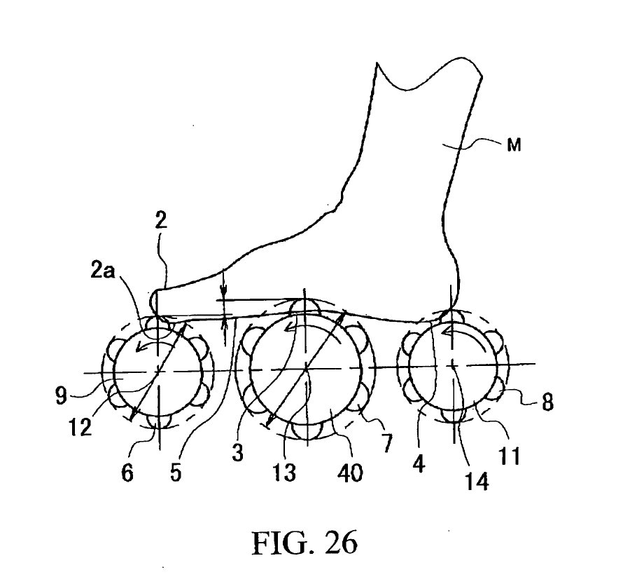

FIG. 26 is a schematic view according to the second embodiment of the present invention. The symbol 40 in FIG. 26 is substituted for roller 10. The driving shaft 13 of the roller 40 is located at the same level as the driving shafts 12, 14 of the other rollers 9 and 11. The roller 40 has a protrusion 7 facing the foot arch 3 and a driving locus closer to the therapeutic portion than a driving locus of the protrusions 6, 8 on the rollers 9. 11 facing a foot portion other than the foot arch 3. The second, third, fourth rolling components 33, 35, and 36 on the sides of the foot arch 3 have greater outer diameters than the diameter of the first roller 32 on the outside of the foot arch 3. Thus, the present invention provides more effective stimulation particularly on the foot arch 3.

Third Embodiment

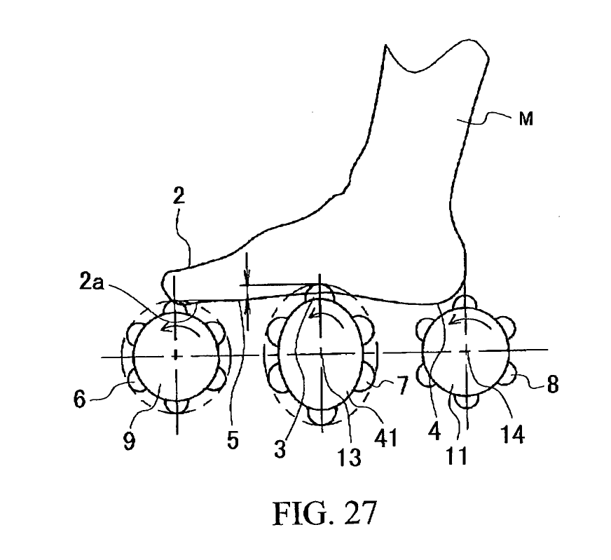

FIG. 27 is a schematic view according to the third embodiment of the present invention. The symbol 41 in FIG. 27 is substituted for roller 10. The driving shaft 13 of the roller 41 is located at the same level as the driving shafts 12, 14 of the other rollers 9 and 11. The roller 41 has an elliptical cross section, having a protrusion 7 facing the foot arch 3. The driving locus of the roller 41 is closer to the therapeutic portion than a driving locus of the protrusions 6, 8 on the rollers 9, 11 facing a foot portion other than the foot arch 3. The second, third, fourth rolling components 33, 35, and 36 on the sides of the foot arch 3 have greater outer diameters than the diameter of the first roller 32 on the outside of the foot arch 3. Thus, the present invention provides more effective stimulation particularly on the foot arch 3.

Fourth Embodiment

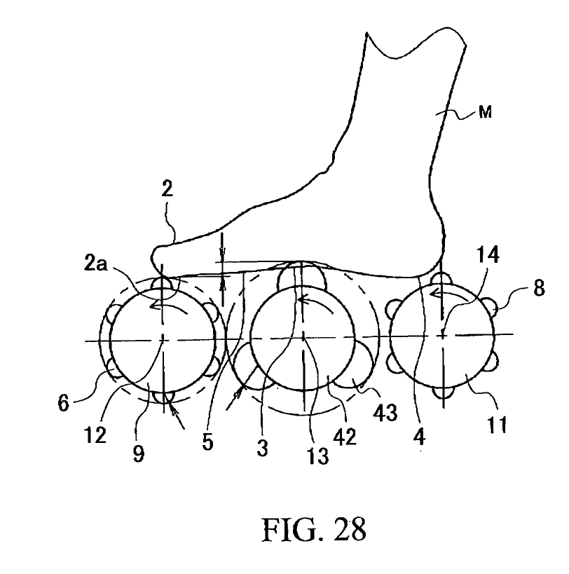

FIG. 28 is a schematic view according to the fourth embodiment of the present invention. The symbol 42 in FIG. 28 is substituted for roller 10. The driving shaft 13 of the roller 42 is located at the same level as the driving shafts 12, 14 of the other rollers 9 and 11. The roller 42 has a large protrusion 43 with large diameter, facing the foot arch 3. The driving locus of the roller 42 is closer to the therapeutic portion than a driving locus of the protrusions 6, 8 on the rollers 9. 11 facing a foot portion other than the foot arch 3. The second, third, fourth rolling components 33, 35, and 36 on the sides of the foot arch 3 have greater outer diameters than the diameter of the first roller 32 on the outside of the foot arch 3. Thus, the present invention provides more effective stimulation particularly on the foot arch 3.

Fifth Embodiment

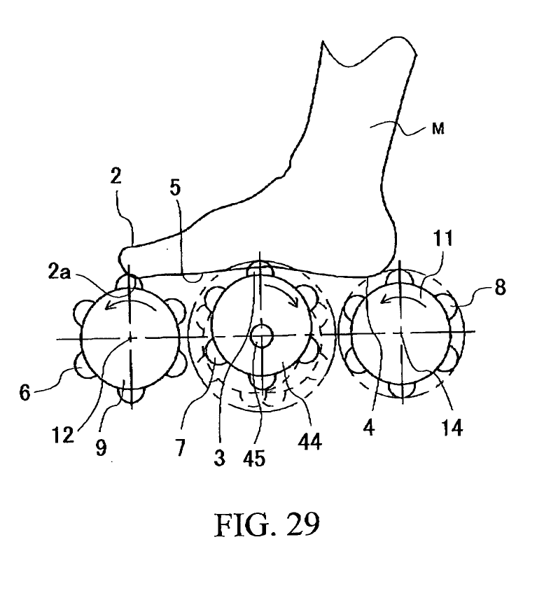

FIG. 29 is a schematic view according to the fifth embodiment of the present invention. The symbol 44 in FIG. 29 is substitute for roller 10. The driving shaft 45 of the roller 44 is located at the same level as the driving shafts 12, 14 of the other rollers 9 and 11. The roller 44 facing the foot arch 3 has the same circular cross section as those of the other rollers 9 and 11, eccentrically supported together. The driving locus of the roller 44 is closer to the therapeutic portion than a driving locus of the protrusions 6, 8 on the rollers 9. 11 facing a foot portion other than the foot arch 3. The second, third, fourth rolling components 33, 35, and 36 on the sides of the foot arch 3 have greater outer diameters than the diameter of the first roller 32 on the outside of the foot arch 3. Thus, the present invention provides more effective stimulation particularly on the foot arch 3.

Sixth Embodiment

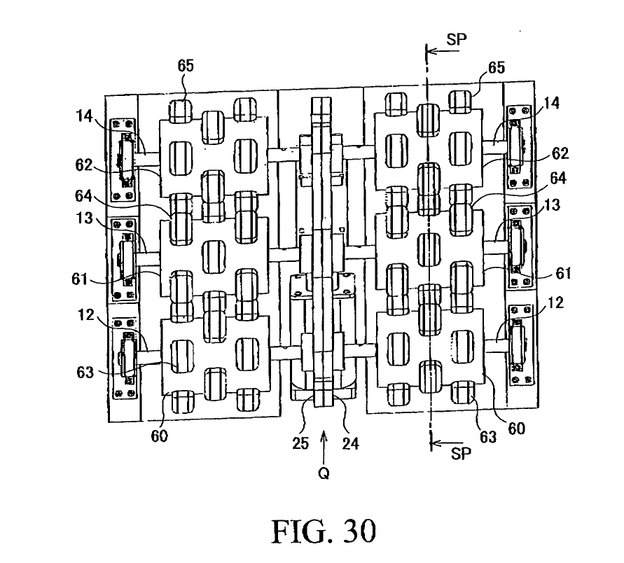

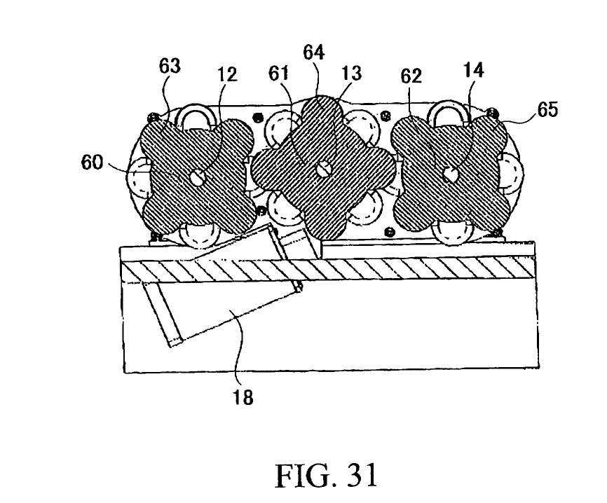

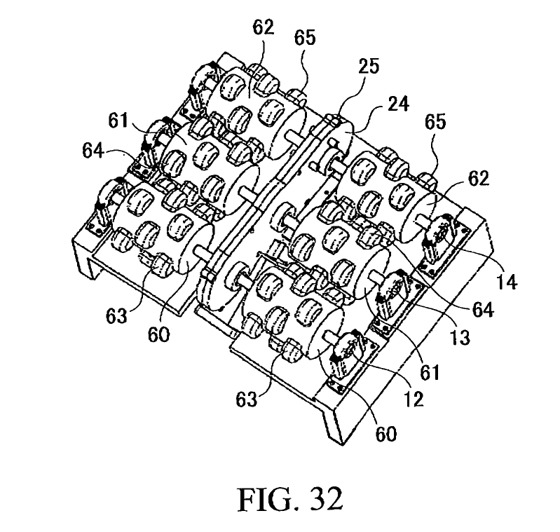

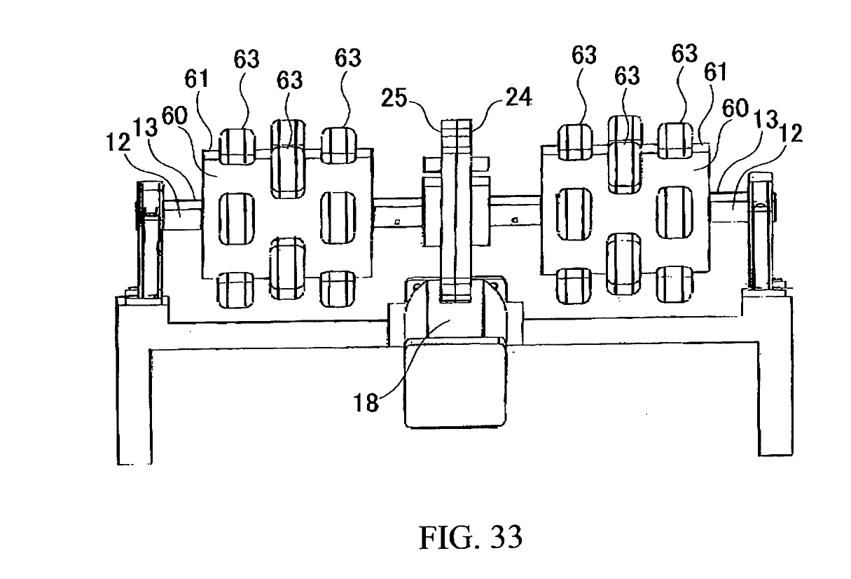

FIGS. 30-33 are schematic views according to the sixth embodiment of the present invention. The symbol 60, 61, and 62 in FIGS. 30-33 are substituted for rollers 9, 10, and 11. The driving shaft 13 of the roller 61 is higher than the driving shafts 12, 14 of the other rollers 60 and 62, with the same positional relationship as described in the first embodiment. The protrusion 64 of the roller 61 facing the foot arch 3 has a driving locus closer to the therapeutic portion than a driving locus of the protrusions 63, 65 on the rollers 60, 62 facing a foot portion other than the foot arch 3. The protrusions 63, 64, and 65 of the second, third, fourth rollers 60, 61, and 62 have the same shape as the mentioned rolling pieces. Thus, the present invention provides more effective stimulation particularly on the foot arch 3. Further, the protrusions 63, 64, and 65 can be removed, providing compact size and saving space.

Seventh Embodiment

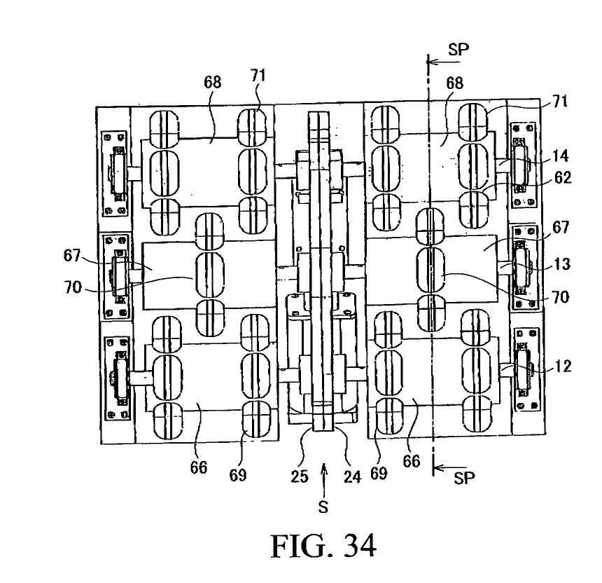

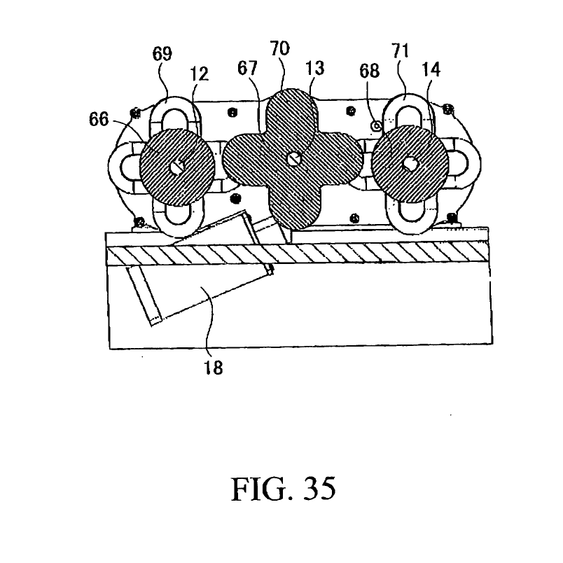

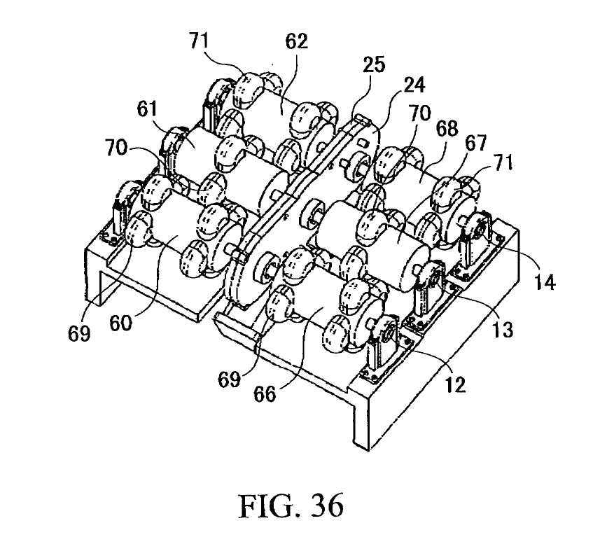

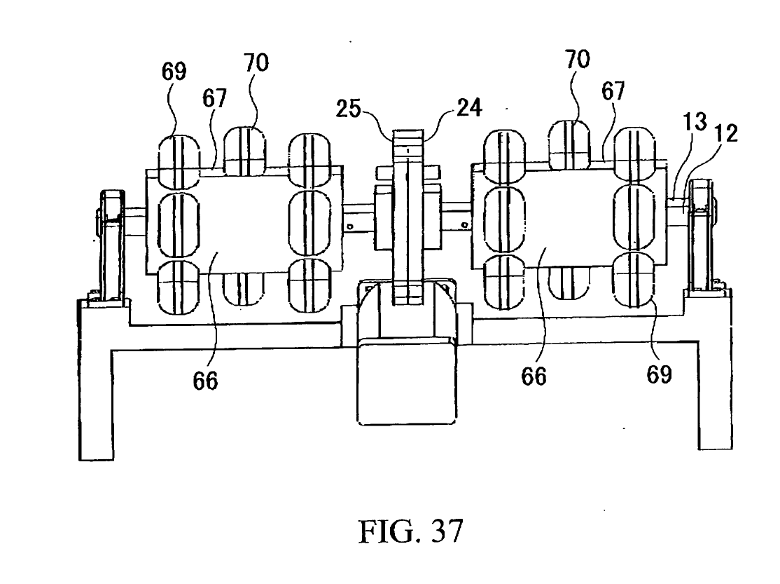

FIGS. 34-37 are schematic views according to the seventh embodiment of the present invention. The symbol 66, 67, and 68 in FIGS. 34-37 are substituted for rollers 9, 10, and 11. The driving shaft 13 of the roller 67 is higher than the driving shafts 12, 14 of the other rollers 66 and 68, with the same positional relationship as described in the first embodiment. The protrusion 70 of the roller 67 facing the foot arch 3 has a driving locus closer to the therapeutic portion than a driving locus of the protrusions 69, 71 on the rollers 66, 68 facing a foot portion other than the foot arch 3. The protrusions 69, 70, and 71 of the second, third, fourth rollers 66, 67, and 68 have the same shape as the rolling pieces. Thus, the present invention provides more effective stimulation particularly on the foot arch 3. Further, the protrusions 69, 70, and 71 can be removed, providing compact size and saving space.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A massage device, comprising:
a driving mechanism; and
a plurality of rollers, each having a therapeutic protrusion, facing two intended locations of a sole and an arch of a foot, generating pressure higher than pressure exerted by a surface of the sole of the foot; wherein the rollers are rotatably driven in a predetermined direction by the driving mechanism.

2. The massage device as claimed in claim 1 wherein any two adjacent rollers are rotatably driven in opposite directions.

3. The massage device as claimed in claim 1, wherein the therapeutic protrusion on the rollers is disposed on an outer surface thereof, and freely supported by the roller.

4. The massage device as claimed in claim 2, wherein the therapeutic protrusion on the rollers is disposed on an outer surface thereof, and freely supported by the roller.

5. The massage device as claimed in claim 1, wherein the rollers include a plurality of rotational shafts, disposed on the same level; wherein one of the rollers has a protrusion facing the arch of the foot and a driving locus closer to a therapeutic portion than a driving locus of a protrusion on one of the rollers facing a foot portion other than the arch.

6. The massage device as claimed in claim 2, wherein the rollers include a plurality of rotational shafts, disposed on the same level; wherein one of the rollers has a protrusion facing the arch of the foot and a driving locus closer to a therapeutic portion than a driving locus of a protrusion on one of the rollers facing a foot portion other than the arch.

7. The massage device as claimed in claim 3, wherein the rollers include a plurality of rotational shafts, disposed on the same level; wherein one of the rollers has a protrusion facing the arch of the foot and a driving locus closer to a therapeutic portion than a driving locus of a protrusion on one of the rollers facing a foot portion other than the arch.

8. A massage device, comprising:
a driving mechanism; and
a plurality of rollers, each having a therapeutic protrusion, facing three intended locations of a sole, an arch, and a heel of a foot, generating pressure higher than pressure exerted by a surface of the sole of the foot; wherein the rollers are rotatably driven in a predetermined direction by the driving mechanism.

9. The massage device as claimed in claim 8 wherein any two adjacent rollers are rotatably driven in opposite directions.

10. The massage device as claimed in claim 8, wherein the therapeutic protrusion on the rollers is disposed on an outer surface thereof, and freely supported by the roller.

11. The massage device as claimed in claim 9, wherein the therapeutic protrusion on the rollers is disposed on an outer surface thereof, and freely supported by the roller.

12. The massage device as claimed in claim 8, wherein the rollers include a plurality of rotational shafts, disposed on the same level; wherein one of the rollers has a protrusion facing the arch of the foot and a driving locus closer to a therapeutic portion than a driving locus of a protrusion on one of the rollers facing a foot portion other than the arch.

13. The massage device as claimed in claim 9, wherein the rollers include a plurality of rotational shafts, disposed on the same level; wherein one of the rollers has a protrusion facing the arch of the foot and a driving locus closer to a therapeutic portion than a driving locus of a protrusion on one of the rollers facing a foot portion other than the arch.

14. The massage device as claimed in claim 10, wherein the rollers include a plurality of rotational shafts, disposed on the same level; wherein one of the rollers has a protrusion facing the arch of the foot and a driving locus closer to a therapeutic portion than a driving locus of a protrusion on one of the rollers facing a foot portion other than the arch.

15. The massage device as claimed in claim 4, wherein the rollers include a plurality of rotational shafts, disposed on the same level; wherein one of the rollers has a protrusion facing the arch of the foot and a driving locus closer to a therapeutic portion than a driving locus of a protrusion on one of the rollers facing a foot portion other than the arch.

16. The massage device as claimed in claim 11, wherein the rollers include a plurality of rotational shafts, disposed on the same level; wherein one of the rollers has a protrusion facing the arch of the foot and a driving locus closer to a therapeutic portion than a driving locus of a protrusion on one of the rollers facing a foot portion other than the arch.
